(19) United States
(12) Patent Application Publication
(10) Pub. No.: US 2007/0057977 A1
(43) Pub. Date: Mar. 15, 2007

(54) Flat panel electrostatic discharge protection device

(76) Inventors: Po-Sheng Shih, Yang-Mei (TW); Hsuan-Lin Pan, Tao-Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,115

(22) Filed: Sep. 14, 2005

(51) Int. Cl. B41J 3/00; B41J 2/175

(52) U.S. Cl. 347/2; 347/86

(57) ABSTRACT

A circuit for reducing the risk of electrostatic damage to flat panel displays during manufacture and use. A plurality of common voltage coupling points is provided for each of the plurality of driver integrated circuit, arranged to minimize the maximum distance between a signal line and a common voltage coupling point. This significantly reduces the potential for damage to the display by electrostatic discharge due to excessive active area voltage.

### BACKGROUND OF THE INVENTION

1. Field of the Invention

The present invention relates to protection against electrostatic discharge. More specifically, the present invention discloses a structure for protection of flat panel displays from damages due to electrostatic discharge.

2. Description of the Prior Art

Traditionally, electrostatic damage protection circuitry for flat panel displays focus on protection during the manufacturing process. However, electrostatic discharge (ESD) damage can result in high scrap and failure rates, during the final stages of manufacturing and during use respectively.

Please refer to FIG. 1, which shows flat panel display components of the prior art. The flat panel display 100 has a display panel 40 with an active area 50. A plurality of source driver integrated circuits (ICs) 61 are attached along one edge, and a plurality of gate driver integrated circuits (ICs) 62 are attached along an orthogonal edge. These source driver ICs 61 and gate driver ICs 62 have a plurality of output lines (not shown) which are coupled to addressable signal lines. A common voltage line 70 is coupled to a voltage source. The common voltage line 70 has a pair of common line coupling points 1 used by the source driver ICs 61, one at each end of the edge of the display, and a pair of common line coupling points 1 used by the gate driver ICs 62, one at each end of the edge of the display.

However, despite the protection that this provides, the flat panel displays are still frequently damaged by electrostatic discharge. Flat panel displays are typically very expensive, and such damage is costly to manufacturers and users.

There are numerous levels of screen resolution. The resolution is determined by the number of pixels that a display contains. For example, VGA has 640 columns and 480 rows, SVGA has 800 columns and 600 rows, XGA has 1024 columns and 768 rows, SXGA has 1280 columns and 1024 rows, SXGA Plus has 1400 columns and 1050 rows, UXGA has 1600 columns and 1200 rows, and WUXGA has 1920 columns and 1200 rows. Currently, a typical driver IC is capable of driving 480 signal lines. However, other driver ICs may have lesser or greater capabilities. Therefore, in order to provide a resolution of WUXGA, at least 12 standard source driver ICs, each capable of driving 480 lines, are required.

Please refer to Table 1, which shows the active area voltages for given input voltages for the prior art flat panel display as shown in FIG. 1.

In the test producing the results shown in Table 1, the driver IC chips (more specifically, the source driver IC chips 61 and gate driver IC chips 62 shown in FIG. 1) were each capable of driving 480 signal lines. The total number of signal lines all of the source driver ICs were driving is shown as the number of pin inputs to control a given number of signal lines.

The input voltage used in the test was a 1 ms pulse. The active area voltage was measured at the input of the active area loading.

TABLE 1

| | Active Area Voltage (V) | | | | | |
|---|---|---|---|---|---|---|
| Input | 240 | 480 | 1200 | 1440 | 1920 | 2160 |
| Voltage | pin | pin | pin | pin | pin | pin |
| (V) | input | input | input | input | input | input |
| 400 | 372.6 | 379.6 | 386.3 | 387.1 | 387.6 | 387.5 |
| 800 | 591.4 | 652.6 | 708.0 | 714.0 | 718.2 | 717.2 |
| 1200 | 803.5 | 921.2 | 1027.1 | 1038.4 | 1046.5 | 1044.6 |
| 1600 | 1014.5 | 1189.0 | 1345.7 | 1362.5 | 1374.3 | 1371.5 |
| 2000 | 1225.0 | 1456.4 | 1664.1 | 1686.3 | 1702.0 | 1698.3 |

Of particular note is the worst case situation of the 1920 pin input where the active area voltage is 85% to 97% of the input voltage. In this instance, the maximum distance between coupling points is 1920 signal lines.

The higher the active area voltage shown in Table 1, the more likely it is that the display will be damaged, and hence the greater the need for better protection against ESD.

Therefore there is need for improvement in electrostatic damage protection which prevents damage to display panels or circuitry from electrostatic discharge.

### SUMMARY OF THE INVENTION

To achieve these and other advantages and in order to overcome the disadvantages of the conventional method in accordance with the purpose of the invention as embodied and broadly described herein, the present invention provides an electrostatic discharge protection device comprising a plurality of common voltage points arranged among the signal lines of a driver integrated circuit chip and between driver ICs, thereby reducing the maximum electrical distance between a signal line and a common voltage point.

The present invention further provides a method for protecting flat panel displays from electrostatic damage, by providing a plurality of common voltage input points for each driver integrated circuit chip.

The present invention provides a flat panel display electrostatic discharge protection circuit comprising a driver integrated circuit used in the flat panel display through a plurality of signal lines. The plurality of signal lines comprise a first compensation line arranged on one of two edge sides of the plurality of signal lines and a second compensation line arranged between two edge sides of the plurality of signal lines. The first compensation lines and the second compensation line couple to a shorting bar circuit for providing a common voltage. A plurality of first protection circuits are provided between the shorting bar circuit and the driver integrated circuit. The plurality of first protection circuits comprise a pair of voltage control elements connected in parallel in inverse polarity. The voltage control elements are selected from diodes, transistors and resistors. The shorting bar further connects to a second protection circuit for anti-electrostatic discharge. Furthermore, the distance between the first compensation line and the second compensation line is less than or equal to the distance between two of the first compensation lines.

In the present invention, a plurality of Vcommon or common voltage input pads are provided on both sides of the driver integrated circuits and in the middle of the outer lead bonding (OLB) pads connecting the signal lines to the driver integrated circuits. This substantially increases the electrostatic discharge protection level.

The present invention further allows providing more than one Vcommon pad situated at different places between signal lines. For example, two Vcommon pads could be provided at positions of ⅓ and 2/3 of the driver IC width instead of one Vcommon pad at 1/2 of the driver IC width.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram of a prior art flat panel display;

FIG. 2 is a circuit diagram of display driver circuitry with electrostatic discharge protection according to an embodiment of the present invention;

FIGS. 3A-3C are diagrams illustrating flat panel displays according to embodiments of the present invention; and

FIG. 4 is a diagram illustrating details of a flat panel display according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Analysis of electrostatic discharge damage to flat panel displays shows that ESD resistance is unrelated to diode dimensions. Also, the resistance and capacitance of the fan-out line, the common line, and the signal line can not account for the ESD difference. To reduce the voltage, it is necessary to reduce the maximum electrical distance between the signal lines and the common voltage Vcommon.

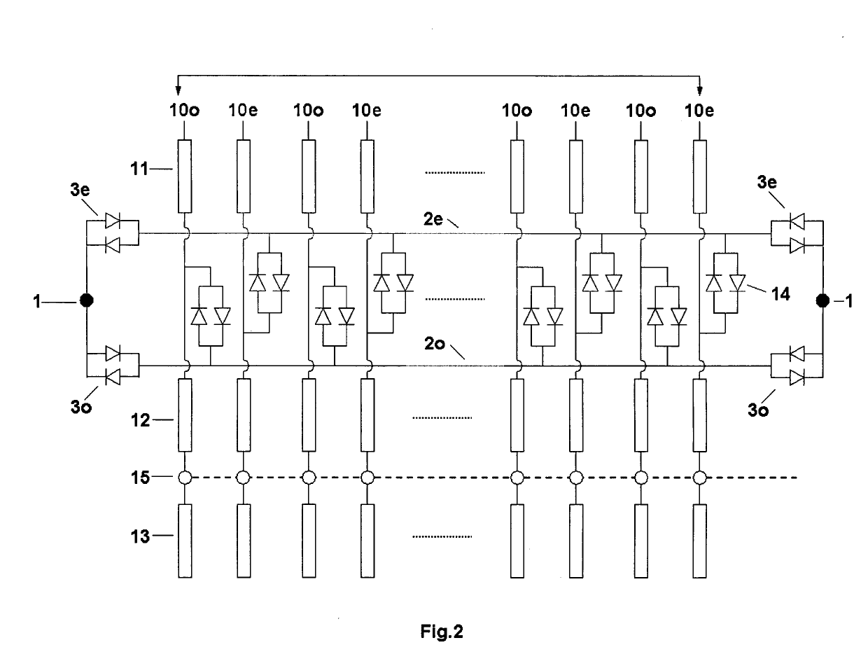

Please refer to FIG. 2, which shows a circuit diagram of display driver circuitry with ESD protection circuitry according to an embodiment of the present invention. A source driver integrated circuit (not shown) is coupled to a plurality of addressable signal lines 10e˜10o organized into even (10e) and odd (10o) signal lines. Each even or odd signal line is coupled to a first fanout RC loading circuit 11, which is coupled both to a pair of voltage control elements 14 and to a second fanout RC loading circuit 12.

The second fanout RC loading circuit 12 is coupled to an active area RC loading circuit 13. Between the second fanout RC loading circuit 12 and the active area RC loading circuit 13 is a measuring point 15 at which test measurements of voltages were taken during testing.

The voltage control elements 14 are coupled to Vcom by one of two common shorting bars 2e,2o. The odd signal lines 10o are coupled to the odd common shorting bar 2o, while the even signal lines 10e are coupled to the even common shorting bar 2e. In addition, the even common shorting bar 2e is further coupled at each end to a pair of voltage control elements 3e for electrostatic discharge issue. The odd common shorting bar 2o is also further coupled at each end to a pair of voltage control elements 3o for anti-electrostatic discharge. The voltage control elements 3e, 3o are coupled to Vcom through a common voltage coupling point 1.

The voltage control elements 3e, 3o and 14 are illustrated in FIG. 2 as a diode pair connected in parallel in inverse polarity. However, the voltage control elements 3e, 3o and 14 can be selected from diodes, transistors, resistors, or other components and circuitry which provide protection against electrostatic discharge damage.

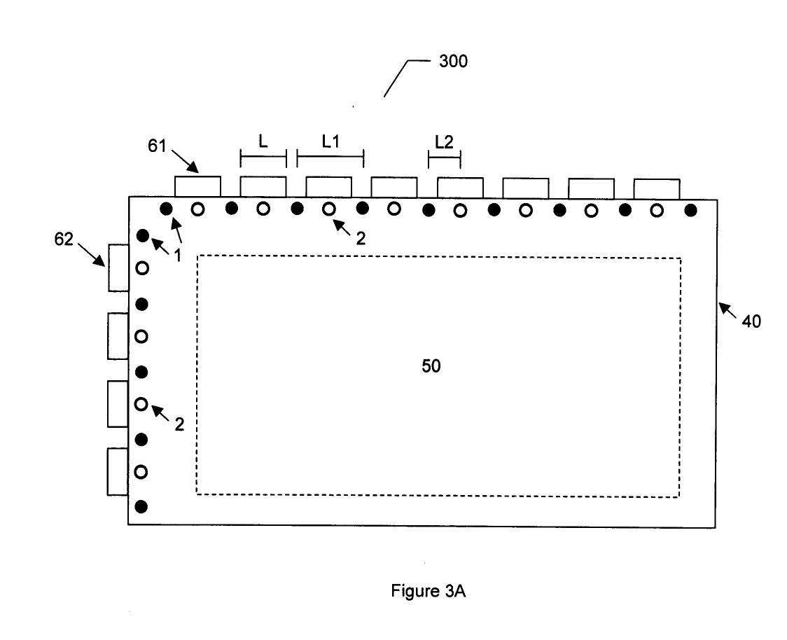

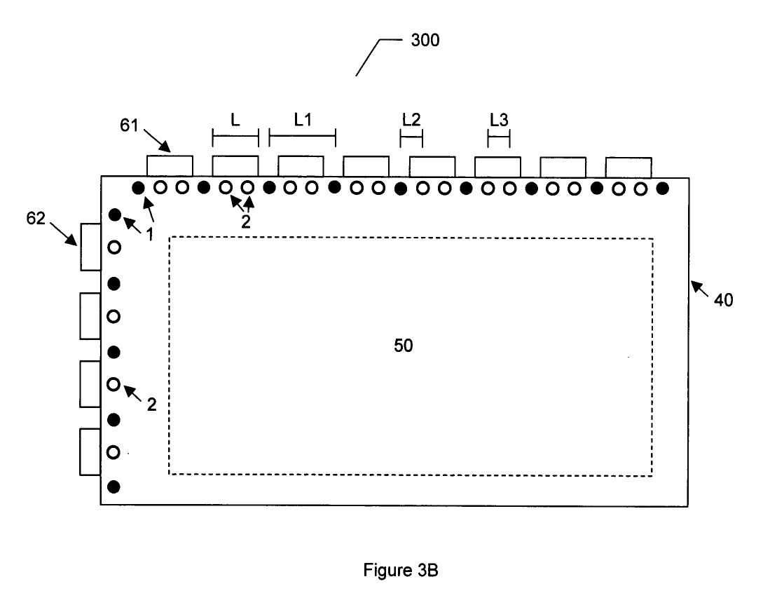

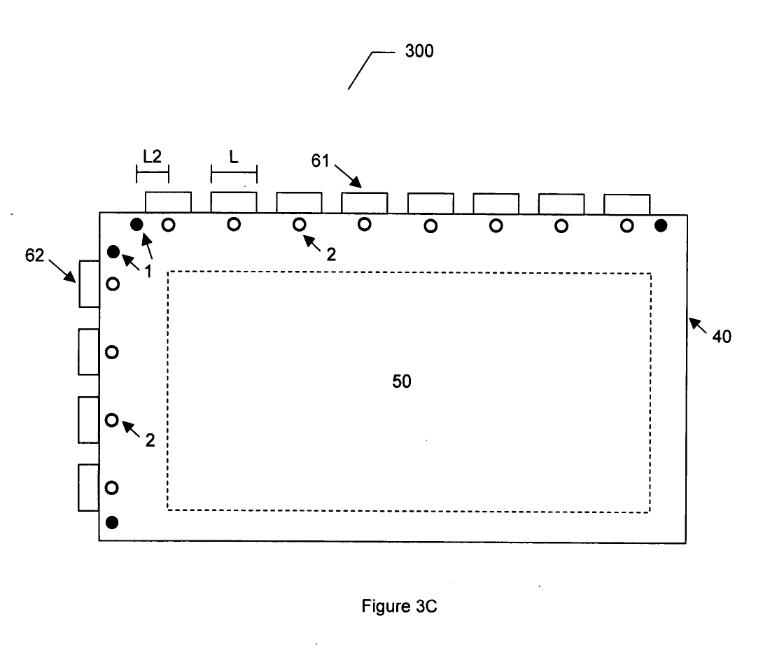

Please refer to FIG. 3A, which shows an embodiment of a flat panel display according to an embodiment of the present invention. The flat panel display 300 has a display panel 40 with an active area 50. A plurality of source driver integrated circuits (ICs) 61 are attached to one edge, and a plurality of gate driver integrated circuits (ICs) 62 are attached to an orthogonal edge. These source driver ICs 61 and gate driver ICs 62 are the driver ICs referred to in the discussion of FIG. 2, and each has a plurality of output lines which are coupled to the addressable signal lines 10e, 10o. A common voltage line (not shown) is coupled to a voltage source for the voltage Vcom. The common voltage line (not shown) has a plurality of common voltage coupling points 1,2 per gate driver IC 62 and source driver IC 61 for ESD protection. In this embodiment, the plurality of first common voltage line coupling points 1 are located at each end of the edge of the display and on both sides of each driver IC chip. A plurality of second voltage line coupling points 2 are located centrally to each driver IC chip. For a given number M of source driver IC chips 61, there are 2M+1 common voltage coupling points 1,2 for the signal lines of the source driver IC chips 61, and for a given number N of gate driver IC chips 62, there are 2N+1 common voltage coupling points 1,2 for the signal lines of the gate driver IC chips 62. The coupling points are arranged into two lines, orthogonal to each other, such that the coupling points are spaced equidistantly along the lines, with each driver IC chip having a coupling point near each end and a coupling point near its middle; adjacent driver IC chips share the coupling point located between them.

In FIG. 3A, the width of the driver IC is shown as L, the distance between two first common voltage coupling points 1 is shown as L1, and the distance between a first common voltage coupling point 1 and a second common voltage coupling point 2 is shown as L2. The distance L2 between the first common voltage coupling points 1 and the second common voltage coupling points 2 is ½ driver IC width. The distance between common voltage coupling points 1,2 has been significantly shortened.

In this embodiment, a first driver integrated circuit and a second driver integrated circuit disposed next to the first driver integrated circuit are coupled with the display panel. A first common voltage coupling point is arranged between the first driver integrated circuit and the second driver integrated circuit. A second common voltage coupling point is arranged within each of the first and second driver integrated circuits. A common voltage line is coupled to the first and the second common voltage coupling points. A plurality of protection circuits are coupled between the common voltage line and each of the first and second driver integrated circuits. The first common voltage coupling point is coupled to the first driver integrated circuit and the second driver integrated circuit. In this embodiment, the distance between the first and the second common voltage coupling point of the first driver integrated circuit is equal to the distance between the first and the second common voltage coupling point of the second driver integrated circuit.

Refer to FIG. 3B, which is shows another embodiment of a flat panel display according to an embodiment of the present invention.

In FIG. 3B, the width of the driver IC is shown as L, the distance between two first common voltage coupling points 1 is shown as L1, the distance between a first common voltage coupling point 1 and a second common voltage coupling point 2 is shown as L2, and the distance between two neighbouring second common voltage coupling points 2 is shown as L3.

In this embodiment, two second common voltage coupling points 2 are provided for each driver IC 61, which further minimizes the distance between common voltage coupling points.

In other words, a distance between the first common voltage coupling point 1 and the neighbouring second common voltage coupling point 2 is the same as that of two neighbouring second common voltage coupling points 2.

Alternate embodiments may use larger numbers of second common voltage coupling points 2 per driver IC chip, typically arranged to minimize the maximum distance between any signal line and the common voltage line, thereby further reducing the potential for damage due to ESD from excessive active area voltage.

For example, an embodiment with K second common voltage coupling points 2 per chip and a the plurality of first common voltage line coupling points 1 located at each end of the edge of the display and on both sides of each driver IC chip will have ((K+1)*M)+1 common voltage coupling points 1,2 for the signal lines of the source driver IC chips 61 and ((K+1)*N)+1 common voltage coupling points 1,2 for the signal lines of the gate driver IC chips 62.

Thus, if two common voltage coupling points are provided between the OLB pads connecting to the driver IC, the width of the circuitry illustrated in FIG. 2 would equal ⅓ of the driver IC width.

Obviously, the spacing of the Vcom pads does not have to be equal and the size of the Vcom pads can be smaller, larger, or substantially the same size as the OLB pads.

Refer to FIG. 3C, which shows another embodiment of a flat panel display according to an embodiment of the present invention.

The flat panel display in this embodiment comprises one second common voltage coupling point 2 per chip and a pair of first common voltage coupling points 1 at each end of the edge of the display.

In FIG. 3C, the width of the driver IC is shown as L, and the distance between a first common voltage coupling point 1 and a second common voltage coupling point 2 is shown as L2.

And for example, an embodiment with K second common voltage coupling points 2 per chip and a pair of first common voltage coupling points 1 at each end of the edge of the display will have at least (K*M)+2 common voltage coupling points 1,2 for the signal lines of the source driver IC chips 61 and (K*N)+2 common voltage coupling points 1,2 for the signal lines of the gate driver IC chips 62.

Furthermore, if three second common voltage coupling points are provided to each of the driver ICs, the preferred width between the pair of first common voltage coupling points is divided equally into 3M+1 parts for any two common voltage coupling points. In other word, the distance between the first common voltage coupling point 1 and the neighbouring second common voltage coupling point 2 could be less than or equal to that of two neighbouring second common voltage coupling points 2 of two neighbouring driver ICs or within one driver IC.

Please refer to Table 2, which shows the active area voltages at given input voltages for a flat panel display using the ESD protection method and circuitry of the present invention according to the layout of FIG. 3A.

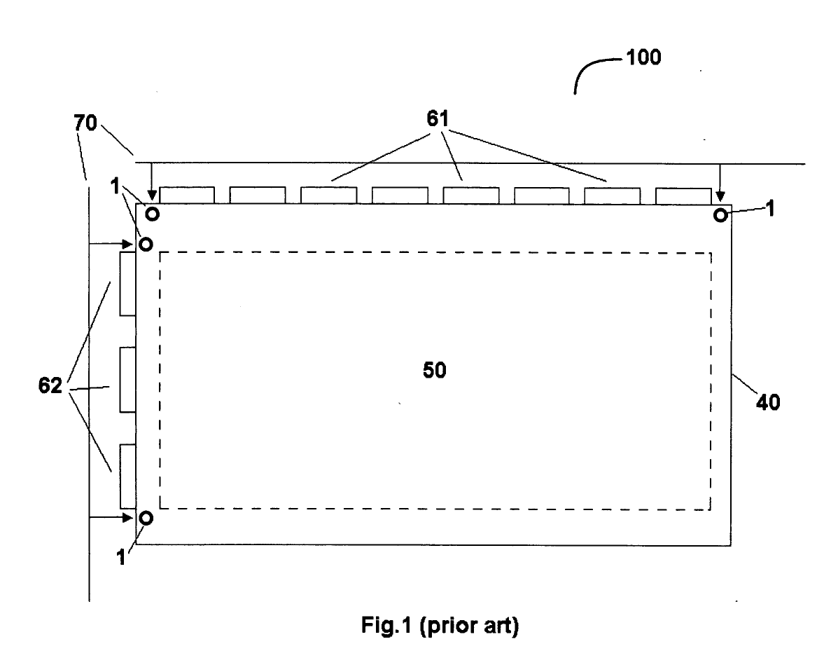

In the test producing the results shown in Table 2, the driver IC chips (more specifically, the source driver IC chips 61 and gate driver IC chips 62 shown in FIG. 1) were each capable of driving 480 signal lines. The total number of signal lines all of the source driver IC's were driving, is shown as the number of pin inputs to control a given number of signal lines.

The input voltage used in the test was a 1 ms pulse. The active area voltage was measured at the input of the active area loading.

TABLE 2

| | Active Area Voltage (V) | | |
|---|---|---|---|
| Input Voltage (V) | 1920 pin input | 1980 pin input | 2040 pin input |
| 400 | 353.1 | 361.5 | 363.8 |
| 800 | 377.9 | 479.6 | 504.7 |
| 1200 | 387.4 | 586.8 | 635.7 |
| 1600 | 394.3 | 691.6 | 762.5 |
| 2000 | 400.2 | 793.7 | 886.0 |

The active area voltage for a flat panel display using the ESD protection method and circuitry of the present invention is lower in all cases than the active area voltage for a prior art flat panel display; and at 2000 input volts, is less than one fourth the voltage of the prior art display. The worst case, in panels with 2040 signal line pin input at 2000 volts, is only about 52% of the worst case of the prior art, at 1920 pins input at 2000 volts. This significantly reduces the risk of damage due to ESD.

In the worst case mentioned above, the maximum distance between coupling points or common voltage points is the space of 240 signal lines since there is one Vcommon pad to the left of the first signal line of each driver IC, one Vcommon pad to the right of the last or 480^{th} signal line and one in the middle approximately next to the 240^{th} signal line. This shortened distance dramatically improves the ESD protection of the display.

Alternatively, additional common voltage points can be added. For example, a plurality of common voltage point can be provided between the signal lines, such as three or four points to further decrease the maximum distance between points.

Comparing other values between tables 1 and 2, it is easy to see the dramatic improvement that the present invention provides in protecting against ESD damage.

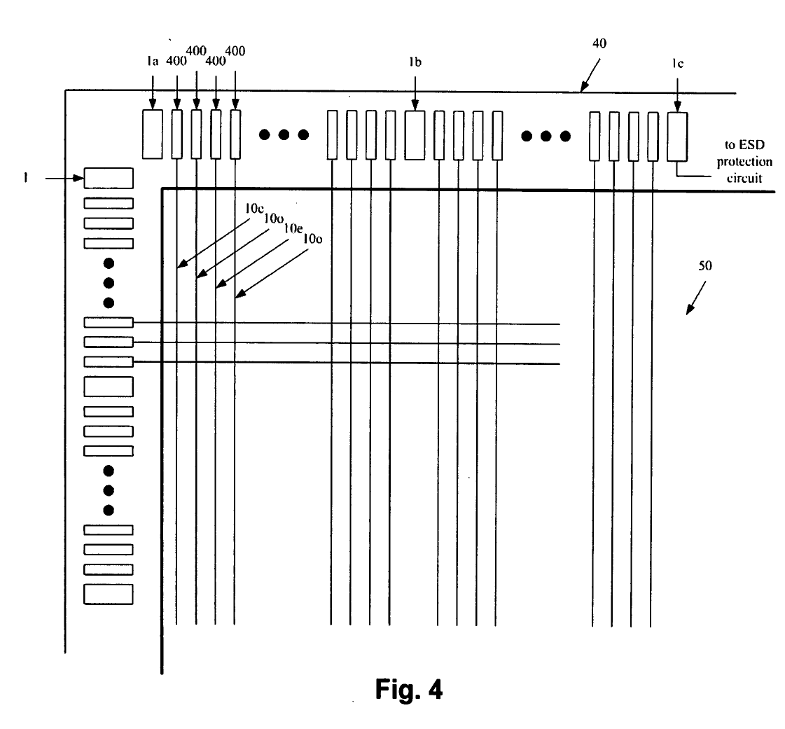

Refer to FIG. 4, which is a diagram illustrating details of a flat panel display according to an embodiment of the present invention.

As shown in FIG. 4, the flat panel display has a display panel 40 with an active area 50. A plurality of outer lead bonding pads 400 are coupled to a plurality of even signal lines 10e and a plurality of odd signal lines 10o. A plurality of common voltage pads 1, 1a, 1b, and 1c are also provided. In this embodiment, a source driver IC capable of driving 480 signal lines is coupled to the outer lead bonding pads 400. A first common voltage pad 1a is positioned to the left of the first signal line 10e. A third common voltage pad 1c is positioned to the right of the 480^{th} signal line. A second common voltage pad 1b is positioned in the middle of the 480 signal lines, approximately next to the 240^{th} signal line. Each common voltage pad 1, 1a, 1b, and 1c is coupled to an ESD protection circuit such as illustrated in FIG. 2.

As shown in FIG. 4, the maximum distance between common voltage pads is approximately the space of 240 signal lines.

FIG. 4 only illustrates an example layout for one source driver IC. For panels with multiple source driver ICs, the layout is repeated for each IC. Also, it should be noted that a plurality of common voltage pads can be positioned between the signal lines.

Furthermore, the ESD protection circuit connected to the common voltage pads can comprise diodes, resistors, capacitors, transistors, or other electronic devices configured to provide ESD protection.

The method and device of the present invention are useful in flat panel displays made with thin film transistor liquid crystal displays (TFT LCD), organic light emitting diodes (OLED), and similar displays using driver IC chips to address pixels in two dimensions.

The electrostatic damage protection device and method of the present invention thus provide a substantial improvement over the prior art by dramatically lowering the peak voltages of electrostatic discharges during manufacturing and use of the flat panel display, thereby lowering failure rates and providing longer service life.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A flat panel display electrostatic discharge protection circuit, comprising:
a plurality of common voltage coupling points for each driver integrated circuit used in the flat panel display;
a plurality of shorting bars coupled to the plurality of common voltage coupling points;
a plurality of signal lines for each driver integrated circuit coupled to the plurality of shorting bars; and
a plurality of first protective circuits between the shorting bars and the signal lines.

2. The flat panel display electrostatic discharge protection circuit of claim 1 further comprising a plurality of second protective circuits between the shorting bars and the common voltage coupling points.

3. The flat panel display electrostatic discharge protection circuit of claim 2, wherein a width of the flat panel display electrostatic discharge protection circuit is less than or equal to one half a width of each driver integrated circuit coupling to the plurality of signal lines.

4. The flat panel display electrostatic discharge protection circuit of claim 1, wherein a distance between the each common voltage coupling points is less than or equal to one half a width of each driver integrated circuit coupling to the plurality of signal lines.

5. The flat panel display electrostatic discharge protection circuit of claim 1, wherein the plurality of common voltage coupling points for each driver integrated circuit are divided by a plurality of equivalent distances of a driver integrated circuit.

6. The flat panel display electrostatic discharge protection circuit of claim 1, wherein the plurality of shorting bars comprises an even shorting bar and an odd shorting bar, the plurality of signal lines comprises a plurality of even signal lines and a plurality of odd signal lines, and the plurality of first protection circuits comprises a plurality of even first protection circuits and a plurality of odd first protection circuits.

7. The flat panel display electrostatic discharge protection circuit of claim 6, wherein each odd signal line is coupled to the odd shorting bar by an odd first protection circuit.

8. The flat panel display electrostatic discharge protection circuit of claim 6, wherein each even signal line is coupled to the even shorting bar by an even first protection circuit.

9. The flat panel display electrostatic discharge protection circuit of claim 1, wherein the plurality of common voltage coupling points are arranged to minimize a maximum distance between a signal line of the plurality of signal lines and a common voltage coupling point of the plurality of common voltage coupling points.

10. The flat panel display electrostatic damage protection circuit of claim 2, wherein each first and second protection circuit comprises a pair of voltage control elements connected in parallel in inverse polarity.

11. The flat panel display electrostatic damage protection circuit of claim 10, wherein the voltage control elements are selected from diodes, transistors and resistors.

12. A flat panel display electrostatic discharge protection circuit, comprising:
a driver integrated circuit used in the flat panel display through a plurality of signal lines, the plurality of signal lines comprising:
a first compensation line arranged on one edge side of the plurality of signal lines; and
a second compensation line arranged between two edge sides of the plurality of signal lines;
wherein the first compensation lines and the second compensation line couple to a shorting bar circuit for providing a common voltage.

13. The flat panel display electrostatic discharge protection circuit of claim 12 further comprising a plurality of first protection circuits between the shorting bar circuit and the driver integrated circuit.

14. The flat panel display electrostatic discharge protection circuit of claim 13, wherein each of the plurality of first protection circuits comprises a pair of voltage control elements connected in parallel in inverse polarity.

15. The flat panel display electrostatic damage protection circuit of claim 14, wherein the voltage control elements are selected from diodes, transistors and resistors.

16. The flat panel display electrostatic discharge protection circuit of claim 13, wherein the shorting bar further connects to a second protection circuit for anti-electrostatic discharge.

17. The flat panel display electrostatic discharge protection circuit of claim 12, wherein a distance between the first compensation line and the second compensation line is less than or equal to a distance between two of the first compensation lines.

18. A display panel, comprising:
a plurality of driver integrated circuits coupled with the display panel out of an active area;
a first common voltage coupling point formed at an end of the edge of the display panel;
a second common voltage coupling point formed within each driver integrated circuit of the plurality of driver integrated circuits; and
a common voltage line coupled to the first and the second common voltage coupling points.

19. The display panel of claim 18 further comprising a plurality of protection circuits between the common voltage line and the plurality of driver integrated circuits.

20. A display panel, comprising:
a first driver integrated circuit coupled with the display panel;
a second driver integrated circuit disposed next to the first driver integrated circuit;
a first common voltage coupling point arranged between the first driver integrated circuit and the second driver integrated circuit;
a second common voltage coupling point arranged within each of the first and second driver integrated circuits; and
a common voltage line coupled to the first and the second common voltage coupling points.

21. The display panel of claim 20 further comprising a plurality of protection circuits between the common voltage line and each of the first and second driver integrated circuits.

22. The display panel of claim 20, wherein the first common voltage coupling point is coupled to the first driver integrated circuit and the second driver integrated circuit.

23. The display panel of claim 20, wherein a distance between the first and the second common voltage coupling point of the first driver integrated circuit is equal to a distance between the first and the second common voltage coupling point of the second driver integrated circuit.
